(19) United States
(12) Patent Application Publication
(10) Pub. No.: US 2023/0142558 A1
(43) Pub. Date: May 11, 2023

(54) Frictionless Retail Stores and Cabinets

(71) Applicant: Swyft, Inc., San Francisco, CA (US)

(72) Inventors: Gower Smith, San Francisco, CA (US); Lincoln Smith, San Francisco, CA (US); Vikranth Katpally, San Francisco, CA (US)

(21) Appl. No.: 17/749,100

(22) Filed: May 19, 2022

Related U.S. Application Data
(60) Provisional application No. 63/190,773, filed on May 19, 2021.

(51) Int. Cl. G07G 1/00; A47F 10/02; G07F 7/00

(52) U.S. Cl. CPC G07G 1/0036; A47F 10/02; G07F 7/00; A47F 2010/025

(57) ABSTRACT

Various examples of the invention conduct a purchase transaction with a first sensor that senses removal or return of a first item from a first region; a computer vision sensor that senses removal or return of a second item from the first region; a transaction detector that determines an accuracy that the sensed removal or return of the first item by the first sensor and the sensed removal or return of the second item by the computer vision sensor correspond to a single event of removal or return of an item by a consumer and that forwards, to a machine learning tool, information associated with the sensed removal or return of the first item by the first sensor and information associated with the sensed removal or return of the second item by the computer vision sensor when the accuracy is less than an accuracy threshold; the machine learning tool that verifies or corrects the information associated with the sensed removal or return of the first item or the information associated with the sensed removal or return of the second item and provides verified or corrected information to the transaction detector; and an automated billing processor, coupled to the transaction detector, that applies a purchase price of the item against an account of the consumer for the item based on the verified or corrected information, thereby completing the purchase transaction.

### CROSS-REFERENCE TO RELATED APPLICATIONS

This application claims priority to U.S. Provisional Application No. 63/190,773 filed on May 19, 2021, which is incorporated herein by reference.

### FIELD OF THE INVENTION

The invention is generally related to retail store technologies and, more particularly to frictionless retail store and/or cabinet technologies.

### BACKGROUND OF THE INVENTION

Frictionless retail store technologies, such as, but not limited to, Amazon Go™, Bingo Box™, and Standard Cognition™, aim to eliminate checkouts and provide a more convenient grab and go experience to consumers. However, such technologies have proven expensive and unscalable due to the return on investment and complexities of implementation. Theft from the lack of security has also proven problematic with such retail store technologies.

What is needed is an improved frictionless retail store and/or cabinet that do not suffer from all of the drawbacks of conventional frictionless retail stores.

### SUMMARY OF THE INVENTION

Various examples of the invention conduct a purchase transaction by sensing, by a first sensor, removal or return of a first item from a first region; sensing, by a computer vision sensor, removal or return of a second item from the first region; verifying that the sensed removal or return of the first item and the sensed removal or return of the second item correspond to a single event of removal or return of an item by a consumer; and applying a purchase price of the item against an account of the consumer for purchase of the item, thereby completing the purchase transaction.

Various examples of the invention capture a video of the removal or return of the second item from the first region.

Various examples of the invention authorize the consumer to access the first region, which may include identifying an account of the consumer to which purchases may be applied and which may include pre-authorizing a charge to an account of the consumer for any potential purchases.

Various examples of the invention identify the second item when sensing removal or return of a second item from the first region. Various examples of the invention identify the second item from a finite list of possible items offered in the first region when sensing removal or return of a second item from the first region.

Various examples of the invention locally verify that the sensed removal or return of the first item and the sensed removal or return of the second item correspond to the single event. Various examples of the invention remotely verify that the sensed removal or return of the first item and the sensed removal or return of the second item correspond to the single event, where the remote verifying may include transmitting, to a backend office, information associated with the sensed removal or return of the first item from the first region; and transmitting, to a backend office, information associated with the sensed removal or return of the second item from the first region. Various examples of the invention transmit a video of the removal or return of the second item from the first region.

Various examples of the invention utilize a machine learning tool to verify that the sensed removal or return of the first item and the sensed removal or return of the second item correspond to the single event.

Various examples of the invention delay applying the purchase price of the item against the account of the consumer until after the remote verifying.

Various examples of the invention correct either the sensed removal of the first item or the sensed removal of the second item in response to the verifying.

Various examples of the invention adjust the applying the purchase price of the item against the account of the consumer in response to the verifying.

Various examples of the invention correcting either the sensed removal or return of the first item or the sensed removal or return of the second item in response to the verifying.

Various examples of the invention feed back the corrected sensed removal or return of the first item or the sensed removal or return of the second item to the machine learning tool for training the machine learning tool.

Various examples of the invention determine an accuracy of the verifying, and determine whether the accuracy of the verifying is below an accuracy threshold.

Various examples of the invention conduct a purchase transaction with a first sensor that senses removal or return of a first item from a first region; a computer vision sensor that senses removal or return of a second item from the first region; a transaction detector that determines an accuracy that the sensed removal or return of the first item by the first sensor and the sensed removal or return of the second item by the computer vision sensor correspond to a single event of removal or return of an item by a consumer and that forwards, to a machine learning tool, information associated with the sensed removal or return of the first item by the first sensor and information associated with the sensed removal or return of the second item by the computer vision sensor when the accuracy is less than an accuracy threshold; the machine learning tool that verifies or corrects the information associated with the sensed removal or return of the first item or the information associated with the sensed removal or return of the second item and provides verified or corrected information to the transaction detector; and an automated billing processor, coupled to the transaction detector, that applies a purchase price of the item against an account of the consumer for the item based on the verified or corrected information, thereby completing the purchase transaction.

### BRIEF DESCRIPTION OF THE DRAWINGS

FIG. 1 illustrates a multi-sensor workflow in accordance with various examples of the invention.

### DETAILED DESCRIPTION

Frictionless retail store technologies (i.e., “frictionless stores”) such as Amazon Go™, Bingo Box™ and Standard Cognition™ aim to eliminate checkouts and provide a more convenient grab and go experience to consumers. In order to address limitations of conventional frictionless stores, examples of improved frictionless stores described herein can: 1) reduce the capital cost by up to ten times; 2) provide a more seamless experience for consumers; and 3) provide a greater degree of security.

Various examples of frictionless stores may include improvements to conventional frictionless stores such as “self-serve retail technology platforms” commercially available from Swyft, Inc., San Francisco, Calif. An example of such a platform is described in U.S. Patent Publication No. US 2020/0387881A1 to Gower et al., and attached hereto, and incorporated herein, as Appendix A. Gower describes its self-serve retail technology platform as a “kiosk;” however, various examples of the invention described herein apply to frictionless stores including kiosks, cabinets, and other secured and unsecured areas within frictionless stores as would be apparent. While examples of the invention are described relative to frictionless stores, various examples of the invention described herein also apply to information technology store rooms, stationery closets, etc., on a corporate campus; and various examples of the invention described herein also apply to lunch delivery methods on a corporate campus or to an information technology asset management tracking system on a corporate campus.

In some examples, a trustworthiness of a consumer in the frictionless store can be determined before providing access to the consumer to higher value items or areas of the store where higher value items are available. This example addresses security concerns of conventional frictionless stores, which provide the same level of access to all items to all consumers in the store. Other metrics associated with the consumer may be used to provide access to alcohol, medications, or other restricted items.

In some examples, frictionless stores may provide consumers an ability to be anonymous and not download an app (i.e., phone or computer application) or opt into providing personally identifiable information to a retail merchant. In such examples, consumers can use various payment methods, including, but not limited to a credit card, a debit card, bank account, electronic payments, crypto currencies, or payment accounts, including store accounts, etc., to pay for items they take from the frictionless stores. Payment methods can be presented to authorize access to the store, or to sections of the store, such that items removed will be automatically billed to the consumer via such payment methods. Consumers can also use QR codes or any other identifiable authentication which link to a website account to authorize access and pay for goods.

In some examples, consumers can opt in to establishing an account in a merchant network (e.g., a Swyft merchant network) and enjoy the ultimate convenience in retail shopping by walking into any related merchant store (e.g., a Swyft Store), taking the items they want and walking out without even presenting their phone or payment method. In some examples, this may be achieved by authentication of a unique identity token such as biometric verification of the consumer as they enter the store or access sections of the store. Payment methods, such as paying with a credit card or linking a bank account, can be tokenized so that each time the authentication method is presented, the payment method can be securely called upon for payment authorization prior to entering the store or for the payment after the goods are taken. Likewise, consumer profiles may be stored, so that the verification method of a unique individual may pull up the individual consumer's profile to permit access to restricted products (e.g., drugs, alcohol, etc.) without the need to validate identity upon each user access session. Various methods of verifying that the consumer is who they are may be used such as facial recognition, finger or palm print recognition, retina scan or the like. Consumers can manage their accounts to decide how to pay for items purchased.

In some examples, the frictionless store may include sections that have restricted access. The restricted sections of the store may include: 1) area(s) where items are displayed openly on shelves with consumers being identified as they enter such restricted section and are tracked through such restricted section such that when they exit the restricted section, they are billed for exactly what they took; and/or 2) area(s) as small as only 3-6 square feet where items are stored in retail showcases with a locked door or cooler cabinets with a locked door and consumers are identified and authorized at the cabinets, where the showcases or cabinets open when the consumer is authorized to access to the items.

As mentioned above, one problem with conventional frictionless stores is the cost of implementation. A conventional authentication system must identify a consumer entering the frictionless store and be able to track them wherever they go through the frictionless store. In such systems, a skeletal image or some other unique identifier for each consumer may be created for each consumer and the consumer is tracked through the frictionless store. Items taken from shelves by the consumer are subsequently billed to the payment method associated with the consumer. However, such designs cannot feasibly require visual coverage of the entire frictionless store as the cost to mount cameras and implement a visual identification system that accurately tracks multiple consumers is expensive. Examples described herein may completely eliminate or substantially reduce the need to track consumers through the entire frictionless store.

In some examples, some items may be stored in a cabinet (e.g., a refrigerated cabinet, etc.). If a store had an open front with cabinets down each side and along the rear wall (e.g., in a “U-shape”), there would be no need for any authentication at the entrance. Each cabinet may have item detection sensors (e.g., cameras), QR code readers, biometric input devices, payment terminals or other such peripherals to identify or authenticate consumers in front of each cabinets. With biometric recognition, a consumer who is known and/or has a valid payment method could have the door of the cabinet they are at automatically unlocked so that they may reach in and remove any item they wish. Sensors, such as cameras with artificial intelligence “AI” vision recognition technology, weight sensors, RFID or other such sensors, may be used to identify which item was removed from in the assortment of items loaded in that cabinet.

In an example, the assortment of items in that cabinet may be a subset (e.g., 20 or so items) of an entire universe of all items in the store. As a result, sensing which item is removed may be faster and more accurate. Likewise, an individual shelf, out of a plurality of shelves in a cabinet, may have sensors that detect the return or removal of items on that shelf, and therefore the subset of items is limited even further. A processor device with software may be incorporated in the cabinet to conduct sensing locally or information from sensors may be transmitted for remote identification (e.g., into the cloud). In some examples, AI vision intelligence may be combined with visual recognition capabilities that present information such as relevant frames or other elements of video or images captured. The images may be used to verify transactions remotely so that consumers are always reliably charged for the items they removed and returned or interacted with.

Various examples include transaction information that can accurately identify the items removed if questions arise. In some examples, AI recognition technology allows the merchant to set the accuracy levels on each SKU in each cabinet in a store so that the merchant can balance human labor costs with desired accuracy levels for the system.

In some examples, transactions where the AI determines the probability of the AI and other sensors automatically determining the correct item from the universe of available items may be identified.

In some examples, many items may be stored in vending machines, robotic warehouses (e.g., robotic vending machines), lockers or other secure dispensing machines. In some examples, these vending machines may be open front with cabinets arranged in a U-shape (or other configuration) inside the store and consumers would be identified when they are shopping at specific cabinets. The secure cabinets would not allow consumers to access all the items in the cabinet, but instead only allow consumers to take the specific items that they requested, and item access/delivery is made only after a verification process. This may be desirable for items such as prescription drugs, alcohol or tobacco, very high value items, ammunition, personalized or other controlled items, licenses, or other such items where the verification process may need to verify age or the identity of the consumer.

In some examples, the frictionless store may combine a combination of the retail cabinets as referenced above with the secure dispensing systems as also referenced above. This format allows the merchant the flexibility to configure the store to deliver the type of experience that is best for the type of merchandise. High value items and items that require higher security and/or verification levels may be merchandised in the secure dispensing systems and the lower value items such as consumables (e.g., food and beverage items, etc.) may be merchandised in the grab and go cabinets.

In some examples, consumers may not have sufficient credit on their account to permit them to take multiple items from a single cabinet. Therefore, each cabinet may be merchandised with like-valued items, and an average charge for that cabinet may be determined over time. Prior to permitting access to the cabinet, consumers' accounts will be preauthorized to ensure there are sufficient funds for an ‘average transaction’ and therefore the liability of loss is limited by the amount a consumer takes over and above an average transaction.”

In some examples, the frictionless store may combine either grab and go cabinets and/or secure dispensing systems with a section of the store that has open shelves and AI, or other sensor-based technology, that both tracks consumers through the store area with open shelves and sensors that detect the items removed from the open shelves. In such examples, consumers are identified as they enter the store open area, the consumers are tracked as they removed or returned items throughout the store open area, and the consumer is subsequently billed for exactly the items removed. The open store area may include a physical barrier such as an entry gate to restrict access to only those consumers who have been identified and verified.

In some examples, consumers who have accounts with a trusted business partner of the merchant may be automatically authorized to access the merchant's frictionless store or a section of the frictionless store. An example may be to use a secure identify platform (e.g., Clear) account by incorporating biometric peripherals at the entry of the store or an area of the store. In such examples, the frictionless store would interface with the secure identify platform's CRM database to verify who the person is.

In some examples, a government database such as INS, or Federal Police or other such database system, may be used to verify the identity of an individual in real time, or substantially real time, and to provide access to the various cabinets based on that verification. Verification may also utilize partner online systems with the consumer opting in to allow the capture of personally identifiable information. For example, facial images captured from a camera may be combined with other personally identifiable information from partner systems and encrypted and stored so that the consumer can shop at any merchant store even if the store is not equipped with the specific partner input peripherals.

In some examples, the integration with trusted partners may also allow the trusted partners to share certain information back to the merchant such as age and/or status, where such information may then be used by the merchant to authorize access to certain items in the merchant's frictionless stores. These examples could be used to reward loyalty, change prices, provide access to specific categories of restricted items, create a trust factor to prevent fraudulent transactions and/or use in other logic associated with the consumers access to items in the merchant's frictionless stores.

In some examples, a token, such as a corporate identification card, a QR Code from an online site, an airline boarding pass, a phone account by reading an IMEID or other input from a mobile phone, or a driver's license, Social Security Card, or other identification carried by a consumer may be used to verify the individual. Such identification inputs could have a category in a CRM database that is different to the categories described above (e.g., secure identify platforms, government identification) using biometrics that verifies the identification of the person to prevent a token being passed to an unauthorized person such as a minor.

In some examples, the frictionless stores may use computer vision and machine learning models to determine the items removed. This may include pattern recognition, image recognition, and the like.

In addition, occurrences of various events within the frictionless stores are used to determine whether there is an event that requires recall (any relevant element). Focusing on any relevant element creates a more narrow focus of information, and a greater chance of a positive recall. Including review at a backend office or cloud to pick up any false positives or false negatives assists with developing machine learning and deep learning techniques. Focusing on a hierarchy of events allows more accurate results and faster learning (including machine learning) with less information. The following flow illustrates this: 1) Is there an event? (yes/no); 2) If yes, does the event require recognition (e.g., a put or a take and/or of which item)? (yes/no); 3) If yes, conduct recognition of the event; 4) What is the accuracy associated with the recognition (e.g., 90% confident that item removed is a can of Coke)?; 5) Is the accuracy above an acceptable threshold?; 6) If yes, confirm the event; if no, verify the event (e.g., backend office, cloud, local, etc., and either automated or “human in the middle”) to either recategorize or confirm the event; and 7) Feedback the results to any machine learning tools or “human in the middle.” This hierarchy provides a level of triage to reduce the data load of recognizing events. At any time in the flow, if there is a “no,” further steps need not be taken for that event. The feedback may be used to correct/train learning algorithms when an event is incorrectly detected (i.e., a false positive) or an event is incorrectly missed (i.e., a false negative).

These ideas and more are also included in the numbered examples below.

### Example 1

A system provides access to purchase items in retail stores where access to items which are physically secured (e.g., in vending machines, cabinets or robotic storage areas), where access to items is granted by verifying a consumer at the physical location, where the verifying gathers personally identifiable information from the consumer, and verifies such information against a database to authorize access to the items. In some examples, access could be via input of data at a verification point that provides access to items in that section of the store, where the verification is via access to a remote database. In some examples, the system is an open system with an API to access to one or more partner databases that exist outside of the merchant's database, where consumers of the partners may use the merchant's system for verification/access or special pricing. In some examples, a consumer may use a credit card to pay, where the credit card data is tokenized, and/or given a unique identifier. In some examples, the unique identifier is used as part of the consumer profile. Over time, as the consumer provides additional unique information, the consumer profile is built out to identify the consumer with personally identifiable information such as their email address or phone number. In some examples, consumer information and shopping patterns may be collated through linkages in personally identifiable information such as a unique identifier or an email address or phone number, and where doing so merges two groups of information into a single group of information, because the same personally identifiable information (e.g., credit card, email address, etc.) are used on a single transaction together, but were previously used on separate transactions. In some examples, as more credit cards or phone numbers or email addresses are used, the data is merged further, allowing the net of data collection to expand. Data collected and merged in such transactions may include both personally identifiable information, (including but not limited to: account numbers, credit card numbers, biometrics, etc.), and other data (including but is not limited to: shopping data, demographic data, transactional data, data showing intent, usage etc.).

### Example 2

A physical retail store where items are physically secured in only one area of the store requires that consumers be verified before being given access to that area of the store (and thereby to remove items). In some examples, the verification uses biometrics. In some examples, the verification uses an account number or other personal identifying information.

### Example 3

A physical retail store where items are physically secured in more than one area of the store requires that consumers must be verified before being given access to take items stored in each section of the store. In some examples, verification uses include biometrics (e.g., facial recognition). In some examples, the physically secure area may be a retail cabinet or a cooler cabinet whereby consumers authenticate to access the secure area. In some examples, the physically secured area may be a vending machine or a robotic store/warehouse.

### Example 4

Access to the physical retail stores described above may be granted using a capacitive sensor. For example, the consumer touches the door handle enabled with a capacitive sensor which triggers the start of authentication of the consumer. In some examples, the system searches for a nearby smartphone with low-frequency communication enabled, that then searches for an account number associated with the mobile application that is stored on that smartphone to uniquely identify the consumer touching the capacitive sensor. In some examples, the system initiates biometric scans to authenticate and authorize the consumer through biometrics. In some examples, personally identifiable information may not be required, but instead is anonymous and time-based (whether time of day or interval based).

### Example 5

In the physical retail stores described above, items and/or events may be identified using cameras or other sensors. Events may be categorized as an action (either a take or a put) and that action is then classified as the exact or specific action that is determined. For example, a combination of machine learning algorithms and a camera may determine that the frames of the video feed have changed, and therefore this ‘motion sensor’ detects that an event is occurring. The machine learning algorithms may then determine whether or not the event should be classified as an action (e.g., an empty hand entering a cabinet and a hand with an item exiting the cabinet. The hand with the item exiting may be tracked frame by frame as moving directionally left to right or right to left, and therefore would be tracked as exiting (or inversely entering). The results being binary of either an item taken or an item put back. An action (which is a hand with an item) is then classified to determine the exact item, whereby the item in the hand is run against machine learning algorithms that determine that the item taken is a specific and unique item taken.

### Example 6

In the physical retail stores described above, a weight sensor may be used to measure the weight of the shelf prior to the consumer interacting with the shelf and logging the event as a difference in weight at a set point in time (where the weight may be 0 g at 0:00 and −56 g at 0:07, −112g at 0:12, −56 g at 0:15 and then the door closes). Such logging determines that a 56 g item was taken at 0:07 and 0:12, and one was put back at 0:15, leaving a “net of one 56 g item taken” at the end of the session. In some examples, the weight sensor may be a pressure sensor, and the weights are on/off sensors. In some examples, the weight sensor is a laser sensor that determines either the distance from the back of the shelf to the rearmost item (because the items slide forward due to gravity or a pressure pushing system) and the output is the number of units of item taken (because the depth of each item is known and divisible by the change in depth of each lane). In some examples, the weight sensor is an item counter such as an infrared beam that when broken determines that an item has been taken from that location or counts the number of items taken.

### Example 7

In the physical retail stores described above, a merchandise layout may be recorded in a backend office or cloud-based system, which determines where each item should be placed by a technician during the replenishment or stocking process, which creates a known location of each item because a trusted person has placed each item in the correct location manually.

### Example 8

In some examples, video recordings from cameras that sense removal of items may be processed to remove frames that are not necessarily useful to the machine learning algorithms. Removing frames outside of certain time bounds around events reduces the amount of the video that needs to be uploaded and analyzed. In some examples, the events may be determined by other logs on other sensors such as weight sensors, motion sensors, microphones and the like.

### Example 9

In the physical retail stores described above, a merchandise layout may be used to alter the probability of determining that an item that is taken from a particular shelf. For example, if a 56 g item is taken from a particular shelf, and that shelf only holds 56 g items and 80 g items, it may be determined with a high level of accuracy that the 56 g item that was taken. As another example, the camera sensor detects an item taken from shelf two which only offers Butterfinger™ chocolate bars and Snickers™ chocolate bars, it may be determined with a high degree of accuracy that the item removed is either a Butterfinger or a Snickers. In this way, the merchandise layout reduces the number of false positives output from the machine learning algorithm.

### Example 10

Some examples may include a database that dynamically changes to determine the state of the items that were taken by the consumer (the consumer's shopping cart, or what the consumer has in their hands) so that when an item is put back, the item can be determined with very high accuracy. For example, if a consumer has only taken a diet coke and a regular coke, there are only two possible options for the item that is placed back on the shelf, which reduces the number of false positives detected by the machine learning algorithm or the weight sensors.

### Example 11

Some examples may include a database that tracks the state of the planogram that dynamically changes as users move items around the shelving. The planogram is known, and as items are detected as having been taken and put back and from and to which shelves, so that when a particular item is detected as being put back onto a different shelf, the database records the dynamic placement of that particular item on the incorrect shelf and updates probabilities accordingly. In some examples, when the item is put back on the left or the right of the shelf or in a specific item location/slot/chute/lane on the shelf, sensors (e.g., depth sensors, camera sensors, etc.) detect the placement of the item on the shelf, thereby allowing the database to track to the location of the shelf level and not just the shelf level.

### Example 12

In some examples, instructions are provided to the replenisher during the replenishment process of incorrect items on incorrect shelves so that the replenisher can return items back to the desired planogram and therefore remove any of the dynamic discrepancies described above.

### Example 13

In some examples, the replenisher uses a handheld device with a screen to see a visualization of the merchandising layout to highlight the items that need to be moved and the ‘locations/slots/chutes/lanes’ that need to be replenished. The visualization may use color coding, icons or imagery to highlight to the replenisher which parts of the shelves need to be addressed. In some examples, the replenisher uses a handheld device with a camera to view the shelving in augmented reality to highlight to the replenisher/technician which parts of what shelves need to be addressed.

### Example 14

In some examples, feedback may be provided to the consumer in the form of sounds, changing lights, or a shopping cart displayed on a screen. This feedback is a result of machine learning at the local store to determine the result of the event happening. In an example, the transaction is not closed. The log of the transaction (and therefore all data consumed by the local store) is transferred to the backend office or cloud for secondary (and more accurate processing). The events and logs are transferred to the backend office or the cloud and inferences are made. Therefore while instant feedback may be relevant, the classification of the event may be highly discernable.

### Example 15

In some examples, machine learning models can be large and full of various errors, especially when the model includes many items such as various types/flavors of soft drinks (e.g., Classic Coke, Diet Coke, etc.), but only one flavor of soft drink is assorted (and available on the shelf). Accordingly, specific machine learning models which are relevant to only the specific items contained within a shelf or store may be used. This allows machine learning models to be dynamically generated and tailored based on the items sold within a particular shelf or frictionless store. In some examples, as machine learning models are updated with new data on items, the data and training of those items may be automatically deployed for other shelves or frictionless stores that offer that same item. In some examples, these machine learning models may be combined with database information regarding the locations of items on shelves thereby enhancing the machine learning models with the probabilities of certain items existing on certain shelves.

### Example 16

Machine learning models may not accurately detect new items with limited information/experience when those new items are taken from a shelf. Such machine learning models will try to accurately determine the item events/inferences. However, machine learning models may not be able to determine the type of item or the type of action or the event based on a certain threshold of probability. The machine learning model may then raise a flag to indicate that the event, action or object detection cannot be determined with sufficient certainty and as such, requires further review. In some examples, differing items will have differing probability thresholds that can be programmed. In some examples, an overall general accuracy threshold may be set. In some examples, an item-level accuracy threshold may be set. For example, a can of Classic Coke can often be confused for a can of Cherry Coke, and so the threshold for both of those items should be set high (98% for example); however, a Butterfinger chocolate bar is almost never confused for any other item in the assortment, and so the Butterfinger chocolate bar accuracy threshold can be set lower (65% for example). In some examples, the item-level accuracy threshold can be altered based on the other items being offered—so a Coke can have a high accuracy threshold when offered together with other flavors of Coke, but if a low accuracy threshold when offered as a single flavor (i.e., no other flavors offered). This item-level accuracy threshold will change based on the items offered, so when Classic Coke is offered with Cherry Coke, it is 98% (i.e., these items are similar in appearance); when Classic Coke is offered with Diet Coke, it is 75% (i.e., these items are not as similar in appearance), and when Classic Coke is offered as a single flavor, it's 65%. In some examples, the item-level accuracy thresholds are based on calculations rather than fixed numbers, and change over time as the accuracy of the machine learning models improves with more data. As would be appreciated, lower thresholds require fewer review of events which would be expected as the machine learning models improve.

### Example 17

In some examples, when a flag is raised on an event, the event data may be sent to the backend office or cloud-based system for review. A user interface is used to replay the video and log data of the event and a “human in the middle,” or other verification system, determines whether the accuracy of the event was classified correctly or incorrectly based on the video replay and the log data. In some examples, the reclassification of the event is fed back into the machine learning model so that the model is updated with the new correct information, thereby improving future accuracy of similar events.

### Example 18

In some examples, an average dollar amount that a particular consumer is expected to transact may be determined or predicted based on previously collected data. As such, an anticipated ‘preauthorization’ for payment may be sought for the particular consumer from an external third party. This minimizes a likelihood of the particular consumer taking too many items and the transaction being rejected after the fact. In some examples, after the transaction has occurred, the amount of the transaction would be settled for the actual amount of the transaction rather that the anticipated preauthorization. In some examples, the transaction may be left open long enough for the “human in the middle,” or other verification system, to review the transaction prior to closing out the event (i.e., settling the transaction). In some examples, the “human in the middle,” or other verification system, uses a user interface to change the events (i.e., changes the determination of the items taken), which automatically updates and settles the correct transaction amount. In some examples, a receipt is automatically sent to the consumer when there is no flag for the classification of the event. In some examples, the receipt is temporarily withheld from the consumer when there is a flag on the event classification and is sent after review by the “human in the middle,” or other verification system. In some examples, in the event that the preauthorized value is not sufficient for the value of the items taken, the preauthorized token (e.g., a credit card, etc.) is locked out from being further used until sufficient additional funds are made available to cover the initial transaction value. In some examples, in the event that the preauthorized value is not sufficient for the value of the items taken, the tokenized credit card is automatically charged again to ‘round up’ or preauthorize the correct amount of the transaction. In some examples, when there is a round up event that occurs, this corresponding data may be recorded. In some examples, when a token (e.g., credit card, etc.) is presented for preauthorization, the token is compared against prior transactions to see if the preauthorization value should be higher or lower than a predetermined preauthorization value.

### Example 19

In some examples, multiple locations (e.g., cabinets, areas, or sections) in the frictionless store may be located near each other such that a consumer may expect an experience to be treated as a single transaction. When a consumer is identified at a first location and a transaction is conducted there, the transaction is merged with transactions at other locations so that the collective transactions occur as a single transaction for the consumer. In some examples, when the transaction preauthorization at the first location for a specific transaction is low (due to the offered items having low value), but the second location requires a higher transaction preauthorization, a second preauthorization will occur to effectively ‘round up’ the first preauthorization. In some examples, where the transaction preauthorization at the first location for a specific transaction is high (due to the offered items having high value), but the second location requires a lower transaction preauthorization, no second preauthorization will occur, as the first preauthorization will likely be sufficient to cover the liability at the second location. In some examples, the events and classification of the data to determine the items taken may be grouped together so that any required review or any linked receipt or transaction data will be linked to this group of events. In other words, because the overall experience at multiple locations is treated as a single transaction for the consumer, the overall experience is treated a single group of events as well.

### Example 20

In some examples, the consumer may be linked to an account and the account is linked to a digital wallet, where the preauthorization amounts listed in the above examples are cash amounts that are already in the wallet; when further ‘preauthorizations’ are required, the wallet is topped up by its funding source.

### Example 21

In some examples, a retrofit kit may be used to retrofit a commercial refrigerator or a standard cabinet with an array of camera sensors and shelves including weight sensors plus a payment reader such as a credit card scanner or QR scanner to convert a simple device into one of the cabinets described herein.

### Example 22

In some examples, removing the locked door on the front of a cabinet enables another experience to be created. For example, a consumer can just take an item off the shelf without the need to pre-authenticate. This creates a hybrid solution for the merchant, where a merchant with a cash register can install these ‘less secure’ cabinets into their store. The less secure cabinets use the sensor technology to detect events at the time they occur, and raise flags as to the fact that a consumer has taken items and will therefore need to checkout. In some examples, the consumer can pay and then take items, which doesn't alert the store clerk and therefore allows the user to walk out without paying at the cash register. In some examples where the consumers are uniquely identified, the consumer's cart may be virtually taken from cabinet to cabinet, and once finished, the cart may be pre-loaded at the register thereby allowing the consumer to check out at the cash register without scanning the selected items.

### Example 23

In some examples, the videos in the event video feed from cameras use multiple videos and multiple camera angles to classify the events, and the videos may be stitched together into a single file before being uploaded to the backend office or cloud to reduce the size of the file transfer. Once at the backend office or on the cloud, the single file can then be separated into individual videos or be analyzed as a single video. In some examples, the “human in the middle,” or other verification system allows for pinpointing on separate videos.

### Example 24

In some examples, under temperature fluctuations, the distortion of the weight sensors changes due to the metal becoming more rigid or more malleable. Temperature sensors at the shelves may be used to more accurately determine the weight changes on the shelves. In some examples, the cabinet has an electronic lock on the door to lock out consumers when the current temperature of the cabinet is out of range for the weight sensor.

### Example 25

In some examples, camera sensors may use an enclosure with a heater and a fan to move the air inside the enclosure around the camera and to heat the front lens. Doing so stops the camera from fogging up due to condensation when the camera is in a refrigerator that is cooled and the warm air rushes in from the outside of the refrigerator when the door is opened.

### Example 26

In some examples, after a consumer has just completed a transaction at a first cabinet, and engages with a second cabinet, upon a second preauthorization, the consumer is notified that they are not able to return any items from the first transaction during the second transaction.

### Example 27

In some examples, items are categorized in nested hierarchies. For example, a parent item “Starbucks Frappuccino” may be created and the actual child items are nested under this parent item as flavors “Starbucks Frappuccino Mocha” and “Starbucks Frappuccino Vanilla”. In some examples, the machine learning model may determine that an item is the parent item “Starbucks Frappuccino” and may be able to determine this information without determining what the child item (i.e., the flavor) is, so a group of items can be recognized as any one of the group of items. In some examples, the child items may have differing prices. As such, when the machine learning model determines that the item is the parent item but not able to discern which child item, the machine learning model may raise a flag with a ‘loose’ classification of the parent item for review.

### Example 28

In some examples, accuracy of replenishment of the item is important for understanding the current inventory levels and for determining the probability of items being sold. In some examples, the quantity of the items on the shelf (3 facing of these vs 1 facing of that) may be used to determine the probability of the item being taken being this or that. In some examples, the quantity of the items being shipped to the location for replenishment are known through an integration with the warehouse of an ‘advanced ship notice’, and when the replenisher is to place items on the shelf, the sensors may be able to determine based on the expected input whether or not all items have been received or only some of the items have been received. In some examples, when only some of the items are received, a flag is raised and logs and video of the events may be reviewed using a similar ‘human in the middle,’ or other verification system, to determine whether there was any item loss due to theft or misinformation or whether the items were replenished correctly. In some examples, the pushers at the rear of the item chutes/lanes have visible markers on them, and the cameras used for detecting the items taken are able to determine the distance to those markers to determine the current inventory levels (e.g., by dividing by the item depth). In some examples, the cameras used to detect the items taken are used to count the items on the shelf. In some examples, a snapshot of the items is taken and sent to the ‘human in the middle,’ or other verification system, to review and raise flags. In some examples, a snapshot of the items is taken and sent to a computer vision system to recognize that all items are in the correct location. In some examples, pressure pads determine the current inventory levels. In some examples and based on knowing what shipments were received, indicators may be used to tell the replenisher where to place the items, such as using lighting, LCD screens or labels on the shelf, or audio prompts or other indicators to tell the replenisher where to put the items.

### Example 29

In some examples, a photo taken by the replenisher is processed by a computer vision algorithm to determine whether all items are in the correct merchandise layout locations.

### Example 30

In some examples where video records events as they occur, a link to the video of the events occurring or to snapshots of the items being taken can be included with the receipt. In some examples when a courier collects an item on behalf of the consumer who has ordered the item, the preauthorization token is handed to the courier to preauthorize the transaction and remove the appropriate items. In some examples, the recording of the courier removing the items is provided to the consumer ahead of receiving the items along with tracking the item delivery, which allows for a complete visibility of the supply chain.

### Example 31

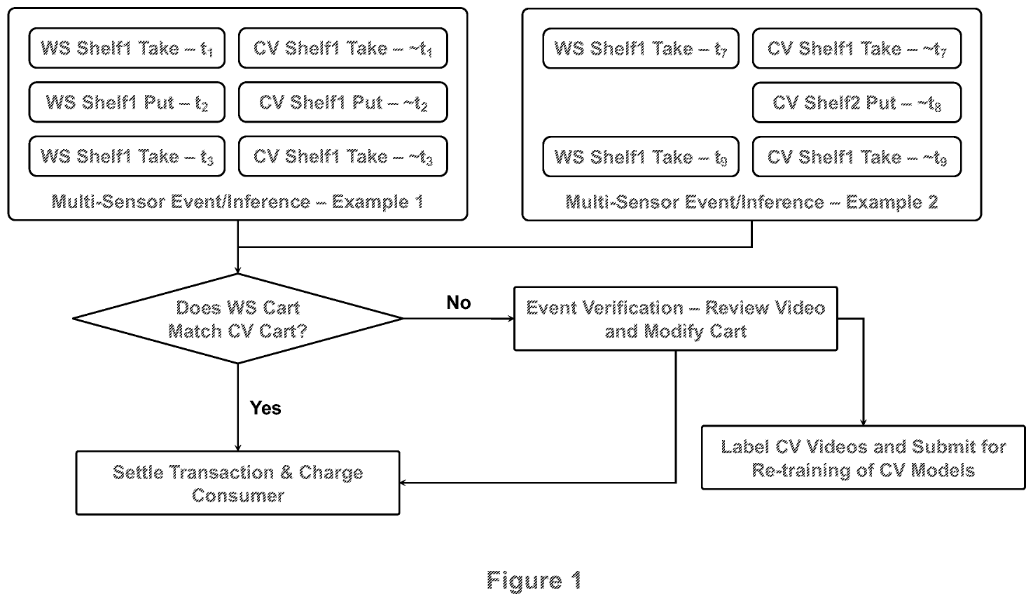

FIG. 1 illustrates a multi-sensor workflow in accordance with various examples of the invention. In FIG. 1 “WS” refers to a weight sensor; “CV” refers to a computer vision sensor; “Shelf1” refers to a first shelf; “Shelf2” refers to a second shelf; “tₙ” refers to a n^{th} time associated with an event; “˜tₙ” refers to the nth approximate time associated with an event to account for a lack of precision in time measurements between the weight sensor and the computer vision sensor; “Take” refers to an item being removed from the shelf by the consumer; and “Put” refers to an item being returned to the shelf by the consumer.

In Example 1 of FIG. 1, the weight sensor identifies a take from the first shelf at t₁, a put to the first shelf at t₂, and a take from the first shelf at t₃; while the computer vision sensor identifies a take from the first shelf at approximately t₁, a put to the first shelf at approximately t₂, and a take from the first shelf at approximately t₃. In Example 1, a comparison between a cart associated with the weight sensor and a cart associated with the computer vision sensor reveals that the two carts are the same and the transaction may proceed to settlement and consumer charge.

In Example 2 of FIG. 1, the weight sensor identifies a take from the first shelf at t₇, and a take from the first shelf at t₉; while the computer vision sensor identifies a take from the first shelf at approximately t₇, a put to the second shelf at approximately t₈, and a take from the first shelf at approximately t₉. In Example 2, a comparison between a cart associated with the weight sensor and a cart associated with the computer vision sensor reveals that the two carts are not the same and the transaction must proceed to event verification which may include video review and modification of the two cart(s) as necessary. Once verified and/or modified, the transaction may proceed to settlement and consumer charge. In addition, in some examples, the videos from the computer vision sensors may be submitted to the machine learning models or “human in the middle” for training.

What is claimed:

1. A method for conducting a purchase transaction comprising:
sensing, by a first sensor, removal or return of a first item from a first region;
sensing, by a computer vision sensor, removal or return of a second item from the first region;
verifying that the sensed removal or return of the first item and the sensed removal or return of the second item correspond to a single event of removal or return of an item by a consumer; and
applying a purchase price of the item against an account of the consumer for purchase of the item, thereby completing the purchase transaction.

2. The method of claim 1, wherein sensing, by a computer vision sensor, removal or return of a second item from the first region comprises capturing a video of the removal or return of the second item from the first region.

3. The method of claim 1, further comprising authorizing the consumer to access the first region.

4. The method of claim 3, wherein the authorizing the consumer to access the first region comprises identifying an account of the consumer to which purchases may be applied.

5. The method of claim 3, wherein the authorizing the consumer to access the first region comprises pre-authorizing a charge to an account of the consumer for any potential purchases.

6. The method of claim 1, wherein sensing, by a computer vision sensor, removal or return of a second item from the first region comprises identifying the second item.

7. The method of claim 6, wherein identifying the second item comprises identifying the second item from a finite list of possible items offered in the first region.

8. The method of claim 1, wherein verifying that the sensed removal or return of the first item and the sensed removal or return of the second item correspond to a single event of removal or return of an item by a consumer comprises locally verifying that the sensed removal or return of the first item and the sensed removal or return of the second item correspond to the single event.

9. The method of claim 1, wherein verifying that the sensed removal or return of the first item and the sensed removal or return of the second item correspond to a single event of removal or return of an item by a consumer comprises remotely verifying that the sensed removal or return of the first item and the sensed removal or return of the second item correspond to the single event.

10. The method of claim 9, wherein remotely verifying that the sensed removal or return of the first item and the sensed removal or return of the second item correspond to the single event comprises:
transmitting, to a backend office, information associated with the sensed removal or return of the first item from the first region; and
transmitting, to a backend office, information associated with the sensed removal or return of the second item from the first region.

11. The method of claim 10, wherein transmitting, to a backend office, information associated with the sensed removal or return of the second item from the first region comprising transmitting a video of the removal or return of the second item from the first region.

12. The method of claim 9, wherein remotely verifying that the sensed removal or return of the first item and the sensed removal or return of the second item correspond to the single event comprises verifying, by a machine learning tool, that the sensed removal or return of the first item and the sensed removal or return of the second item correspond to the single event.

13. The method of claim 9, wherein applying a purchase price of the item against an account of the consumer for purchase of the item comprises delaying the applying the purchase price of the item against the account of the consumer until after the remotely verifying.

14. The method of claim 1, further comprising correcting either the sensed removal or return of the first item or the sensed removal or return of the second item in response to the verifying.

15. The method of claim 1, further comprising adjusting the applying a purchase price of the item against an account of the consumer for purchase of the item in response to the verifying.

16. The method of claim of claim 12, further comprising correcting either the sensed removal or return of the first item or the sensed removal or return of the second item in response to the verifying.

17. The method of claim 16, further comprising feeding back the corrected sensed removal or return of the first item or the sensed removal or return of the second item to the machine learning tool for training the machine learning tool.

18. The method of claim 1, wherein verifying that the sensed removal or return of the first item and the sensed removal or return of the second item correspond to a single event of removal or return of an item by a consumer comprises determining an accuracy of the verifying.

19. The method of claim 18, wherein verifying that the sensed removal or return of the first item and the sensed removal or return of the second item correspond to the single event comprises remotely verifying that the sensed removal or return of the first item and the sensed removal or return of the second item correspond to the single event when the accuracy of the verifying is below an accuracy threshold.

20. A system for conducting a purchase transaction comprising:
a first sensor that senses removal or return of a first item from a first region;
a computer vision sensor that senses removal or return of a second item from the first region;
a transaction detector that determines an accuracy that the sensed removal or return of the first item by the first sensor and the sensed removal or return of the second item by the computer vision sensor correspond to a single event of removal or return of an item by a consumer and that forwards, to a machine learning tool, information associated with the sensed removal or return of the first item by the first sensor and information associated with the sensed removal or return of the second item by the computer vision sensor when the accuracy is less than an accuracy threshold;
the machine learning tool that verifies or corrects the information associated with the sensed removal or return of the first item or the information associated with the sensed removal or return of the second item and provides verified or corrected information to the transaction detector; and
an automated billing processor, coupled to the transaction detector, that applies a purchase price of the item against an account of the consumer for the item based on the verified or corrected information, thereby completing the purchase transaction.
